(19) United States
(12) Patent Application Publication
(10) Pub. No.: US 2025/0105370 A1
(43) Pub. Date: Mar. 27, 2025

(54) FLAME-RETARDANT ELECTRODE AND ALL-SOLID-STATE BATTERY INCLUDING SAME

(71) Applicants: Hyundai Motor Company, Seoul (KR); Kia Corporation, Seoul (KR)

(72) Inventors: Min Sun Kim, Goyang-si (KR); Young Jin Nam, Seoul (KR); Yeo Min Yoon, Hwaseong-si (KR); Yong Seok Choi, Suwon-si (KR); Yong Guk Gwon, Suwon-si (KR)

(21) Appl. No.: 18/600,270

(22) Filed: Mar. 8, 2024

(30) Foreign Application Priority Data
Sep. 21, 2023 (KR) 10-2023-0126474

(51) Int. Cl. H01M 10/42; H01M 4/62; H01M 10/052; H01M 50/383; H01M 50/581

(52) U.S. Cl. CPC H01M 10/4235; H01M 4/625; H01M 10/052; H01M 50/383; H01M 50/581

(57) ABSTRACT

An embodiment of a flame-retardant electrode includes a flame-retardant layer between an electrode current collector and an electrode active material layer, and an embodiment of an all-solid-state battery including the same, in which the flame-retardant layer includes a flame retardant configured such that the surface of a flame-retardant material is coated with a conductive material, thereby increasing thermal stability and adhesion to the electrode current collector.

### CROSS-REFERENCE TO RELATED APPLICATIONS

This application claims, under 35 U.S.C. § 119(a), the benefit of priority from Korean Patent Application No. 10-2023-0126474, filed on Sep. 21, 2023, the entire contents of which are incorporated herein by reference.

### TECHNICAL FIELD

The present disclosure relates to a flame-retardant electrode for an all-solid-state battery.

### BACKGROUND

Recently, to solve environmental problems caused by carbon dioxide (CO₂), the use of fossil fuels has been avoided, so the industry of automobiles as means for transportation is showing great interest in electric vehicles that use secondary batteries.

Secondary batteries store power using materials capable of electrochemical reaction at a cathode and an anode. A representative example of these secondary batteries is a lithium secondary battery that stores electrical energy by a difference in chemical potential when lithium ions are intercalated/deintercalated at a cathode and an anode.

The lithium secondary battery is manufactured in a manner in which a material capable of reversibly intercalating/deintercalating lithium ions is used as a cathode and anode active material and also in which an organic electrolyte solution, a polymer electrolyte solution, or a solid electrolyte is loaded between the cathode and the anode.

When currently developed lithium secondary batteries are used in electric vehicles, they are able to travel about 400 km on a single charge, but problems such as instability, fire, etc. still occur. Specifically, repeated charging and discharging of the secondary battery may cause an internal short circuit between interfaces of individual components included in the secondary battery, which may increase internal resistance and cause thermal runaway. Moreover, thermal runaway may occur even upon damage to the secondary battery due to external shock or external deformation.

When secondary batteries are used in transportation devices such as electric vehicles, thermal runaway of the secondary batteries is directly linked to human life, so thermal stability of the secondary batteries is emerging as a very important factor.

### SUMMARY

The present disclosure relates to a flame-retardant electrode including a flame-retardant layer disposed between an electrode current collector and an electrode active material layer, and an all-solid-state battery including the same, in which the flame-retardant layer can include a flame retardant configured such that the surface of a flame-retardant material is coated with a conductive material, thereby increasing thermal stability and adhesion to the electrode current collector.

Embodiments of the present disclosure have been made keeping in mind the problems encountered in the related art, and can provide an electrode with improved thermal stability by inserting a flame-retardant layer between an electrode current collector and an electrode active material layer, and an all-solid-state battery including the same.

In addition, an embodiment of the present disclosure provides an electrode with increased adhesion by inserting the flame-retardant layer between an electrode current collector and an electrode active material layer.

Embodiments of the present disclosure are not necessarily limited to the foregoing. Embodiments of the present disclosure can be clearly understood through the following description and realized by embodiments corresponding to the claims and combinations thereof.

In an embodiment of the present disclosure, a flame-retardant electrode includes an electrode current collector, an electrode active material layer, and a flame-retardant layer located between the electrode current collector and the electrode active material layer, in which the flame-retardant layer includes a flame retardant with a core-shell structure, a binder, and a first conductive material, and the flame retardant includes a core including a flame-retardant material and a shell including a second conductive material applied onto at least a portion of the surface of the core.

In an embodiment, the thickness of the flame-retardant layer may be 10 μm or less.

In an embodiment, the thickness (w) of the shell may be 2 μm or less.

In an embodiment, the average particle diameter (d₅₀) of the flame retardant may be 3 μm to 5 μm.

In an embodiment, the volume ratio of the core to a sum of the first conductive material and the second conductive material may be 1:1 to 1:100.

In an embodiment, the flame-retardant material may include an inorganic flame-retardant material, a phosphorus (P)-based flame-retardant material, a halogen-based flame-retardant material, a nitrogen (N)-based flame-retardant material, and any combinations thereof.

In an embodiment, the inorganic flame-retardant material may include aluminum hydroxide (Al(OH)₃), magnesium hydroxide (Mg(OH)₂), antimony oxide (Sb₂O₃), tin hydroxide (Sn(OH)₂), tin oxide (SnO), molybdenum oxide (MoO₃), a zirconium compound, a calcium salt, a boron compound, and any combinations thereof.

In an embodiment, the phosphorus (P)-based flame-retardant material may include a red-phosphorus (RP)-based flame-retardant material, a phosphate-based flame-retardant material, a phosphine-based flame-retardant material, a phosphite-based flame-retardant material, a phosphonate-based flame-retardant material, a phosphinate-based flame-retardant material, a phosphoric acid ester flame-retardant material, a phosphoric acid ester and salt flame-retardant material, and any combinations thereof.

In an embodiment, the halogen-based flame-retardant material may include polybrominated diphenyl ether (PBDE), polybrominated biphenyl (PBB), brominated cyclic hydrocarbon, decabromodiphenyl ether (DeBDE), hexabromocyclododecane (HBCDD), tetrabromobisphenol A (TBBP-A), octabromodiphenyl ether (OBDPE), brominated polystyrene, propylene dibromostyrene, brominated epoxy, brominated polycarbonate, chlorinated paraffin, chlorinated polyethylene, alicyclics, and any combinations thereof.

In an embodiment, the nitrogen (N)-based flame-retardant material may include melamine polyphosphate (MPP), melamine cyanurate, melamine, melamine isocyanurate, melamine cyanuric acid, a triazine-based compound, and any combinations thereof.

In an embodiment, adhesion of the flame-retardant layer to the electrode current collector may be 1.20 gf/mm or more.

In an embodiment, the flame-retardant layer may include 0.5 wt % to 5 wt % of the binder.

In an embodiment, the first conductive material and the second conductive material may include a carbon-based conductive material.

In an embodiment of the present disclosure, an all-solid-state battery includes a cathode including the flame-retardant electrode, a solid electrolyte layer on the cathode and including a solid electrolyte, an anode active material layer on the solid electrolyte layer, and an anode current collector on the anode active material layer.

In an embodiment of the present disclosure, an all-solid-state battery includes an anode including the flame-retardant electrode, a solid electrolyte layer on the anode and including a solid electrolyte, a cathode active material layer on the solid electrolyte layer, and a cathode current collector on the cathode active material layer.

### BRIEF DESCRIPTION OF THE DRAWINGS

The above and other features of the present disclosure will now be described in detail referring to certain example embodiments thereof illustrated in the accompanying drawings, which are given hereinbelow by way of illustration only, and thus are not necessarily limitative of the present disclosure, and wherein:

FIG. 1 schematically shows an electrode according to an embodiment of the present disclosure;

FIG. 2 schematically shows the core-shell structure of a flame retardant according to an embodiment of the present disclosure;

FIG. 3 schematically shows a lithium secondary battery in which the electrode according to an embodiment of the present disclosure is applied as a cathode;

FIG. 4 shows a photograph of an accelerating rate calorimeter (ARC) for measuring thermal stability of an all-solid-state battery, according to an embodiment of the present disclosure;

FIG. 5 shows results of analysis of an all-solid-state battery according to an embodiment example using an acceleration rate calorimeter;

FIG. 6 shows results of analysis of a secondary battery according to a comparative example embodiment using an acceleration rate calorimeter;

FIG. 7 shows results of analysis of all-solid-state batteries according to an embodiment example and comparative embodiment examples using differential scanning calorimetry (DSC); and

FIG. 8 shows results of charge/discharge profiles of the all-solid-state batteries according to an embodiment example, a first comparative example embodiment, and a third comparative example embodiment.

### DETAILED DESCRIPTION OF ILLUSTRATIVE EMBODIMENTS

The above and other features and advantages of the present disclosure can be more clearly understood from the following embodiments taken in conjunction with the accompanying drawings. However, the present disclosure is not necessarily limited to the embodiments disclosed herein, and may be modified into different forms. These embodiments are provided to thoroughly explain the disclosure and to sufficiently transfer information illustrating the spirit of the present disclosure to those skilled in the art.

Throughout the drawings, same reference numerals can refer to same or like elements. For the sake of clarity of the present disclosure, the dimensions of structures can be depicted as being larger than the actual sizes thereof. It can be understood that, although terms such as “first,” “second,” etc. may be used herein to describe various elements, these elements are not necessarily limited by these terms. These terms can be only used to distinguish one element from another element. For instance, a “first” element discussed below could be termed a “second” element without necessarily departing from the scope of the present disclosure. Similarly, the “second” element could also be termed a “first” element. As used herein, singular forms can include the plural forms as well, unless the context clearly indicates otherwise.

It can be further understood that the terms “comprise,” “include,” “have,” etc., when used in this specification, specify the presence of stated features, integers, steps, operations, elements, components, or combinations thereof, and do not preclude the presence or addition of one or more other features, integers, steps, operations, elements, components, or combinations thereof. Also, it can be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein can be taken as approximations including various uncertainties affecting measurement that inherently occur in obtaining these values, among others, and thus can be understood to be modified by the term “about” in all cases. Furthermore, when a numerical range is disclosed in this specification, the range can be continuous, and can include all values from the minimum value of said range to the maximum value thereof, unless otherwise indicated. Moreover, when such a range pertains to integer values, all integers including the minimum value to the maximum value can be included, unless otherwise indicated.

In the present specification, when a range is described for a variable, it can be understood that the variable can include all values including the end points described within the stated range. For example, the range of “5 to 10” can be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” can be understood to include subranges, such as 10% to 15%, 12% to 18%, 20% to 30%, etc., as well as all integers including values of 10%, 11%, 12%, 13% and the like up to 30%, and can also be understood to include any value between valid integers within the stated range, such as 10.5%, 15.5%, 25.5%, and the like.

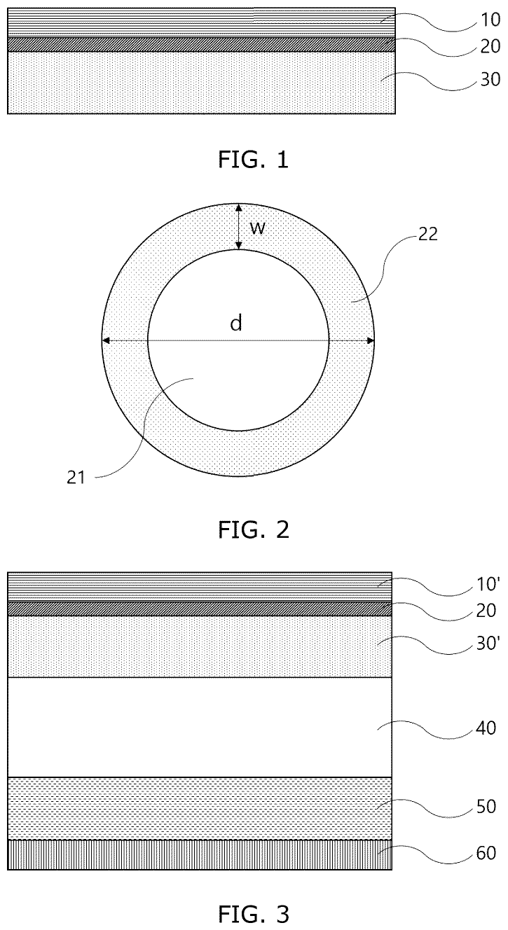

FIG. 1 schematically shows a flame-retardant electrode according to an embodiment of the present disclosure. Referring to FIG. 1, the flame-retardant electrode can include an electrode current collector 10, an electrode active material layer 30, and a flame-retardant layer 20 disposed between the electrode current collector 10 and the electrode active material layer 30. The flame-retardant layer 20 may include a flame retardant with a core-shell structure, a binder, and a first conductive material.

The electrode current collector 10 can serve as a passage to transfer electrons from the outside so that electrochemical reaction occurs in the electrode active material in the battery, or to receive electrons from the electrode active material and send the same to the outside. When the flame-retardant electrode is used as an anode, the electrode current collector 10 may include an anode current collector, and when the flame-retardant electrode is used as a cathode, the electrode current collector 10 may include a cathode current collector.

The electrode active material layer 30 may include an electrode active material involved in electrode reaction of a battery including the flame-retardant electrode. When the flame-retardant electrode is used as a cathode, the electrode active material layer 30 may include a cathode active material layer, and when the flame-retardant electrode is used as an anode, the electrode active material layer 30 may include an anode active material layer.

The flame-retardant layer 20 disposed between the electrode current collector 10 and the electrode active material layer 30 can confer thermal safety by preventing thermal runaway of the flame-retardant electrode, and can increase adhesion to the electrode current collector 10 and the electrode active material layer 30.

The flame-retardant layer 20 may include a layered structure in which the flame retardant, the binder, and the first conductive material are uniformly mixed or dispersed.

The thickness of the flame-retardant layer 20 may be 10 μm or less. When the thickness of the flame-retardant layer 20 is 10 μm or less, thermal stability and adhesion of the electrode may be increased in a balanced manner without deteriorating electrochemical performance of the battery. If the thickness of the flame-retardant layer 20 exceeds 10 μm, energy density of the battery may decrease. The lower limit of the thickness of the flame-retardant layer 20 is not particularly limited. For example, the thickness of the flame-retardant layer 20 may be 100 nm or more, 500 nm or more, or 1 μm or more, for example.

The binder may be a material that mechanically and physically stabilizes the flame-retardant layer 20. The binder may function as a type of adhesive that bonds the flame retardant and the first conductive material to the electrode current collector 10. Examples of the binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), and the like, for example.

The first conductive material may confer electronic conductivity to the flame-retardant layer 20. Accordingly, electrons can move between the electrode current collector 10 and the electrode active material layer 30. The type of first conductive material is not particularly limited and can be a material commonly used in batteries, but may be exemplified by a carbon-based conductive material. For example, the carbon-based conductive material may include carbon black, graphite particles, natural graphite, artificial graphite, acetylene black, Ketjen black, carbon nanofibers, carbon nanotubes, or any combinations thereof.

FIG. 2 schematically shows the core-shell structure of the flame retardant according to an embodiment of the present disclosure. Referring to FIG. 2, the flame retardant may include a core 21 including a flame-retardant material and a shell 22 including a second conductive material applied onto at least a portion of the surface of the core 21.

In general, a flame-retardant material can have lower electronic conductivity than a conductive material. Accordingly, when a flame-retardant layer including a flame-retardant material is between the electrode current collector and the electrode active material layer, electronic conductivity of the electrode may decrease. Because the flame-retardant layer according to an embodiment of the present disclosure includes both the flame retardant and the first conductive material, it can suppress a reduction in electronic conductivity due to the flame retardant. In particular, by coating the surface of the flame-retardant material with the second conductive material, a reduction in electronic conductivity due to the flame-retardant material may be minimized, and higher electronic conductivity may be attained than when the flame-retardant layer includes the first conductive material alone.

In an embodiment, the flame-retardant material may include an endothermic flame-retardant material. For example, the flame-retardant material may include an inorganic flame-retardant material, a phosphorus (P)-based flame-retardant material, a halogen-based flame-retardant material, a nitrogen (N)-based flame-retardant material, or any combinations thereof.

The inorganic flame-retardant material may include aluminum hydroxide (Al(OH)₃), magnesium hydroxide (Mg(OH)₂), antimony oxide (Sb₂O₃), tin hydroxide (Sn(OH)₂), tin oxide (SnO), molybdenum oxide (MoO₃), a zirconium compound, a calcium salt, a boron compound, or any combinations thereof.

The phosphorus (P)-based flame-retardant material may include a red-phosphorus (RP)-based flame-retardant material, a phosphate-based flame-retardant material, a phosphine-based flame-retardant material, a phosphite-based flame-retardant material, a phosphonate-based flame-retardant material, a phosphinate-based flame-retardant material, a phosphoric acid ester flame-retardant material, a phosphoric acid ester and salt flame-retardant material, or any combinations thereof.

The halogen-based flame-retardant material may include polybrominated diphenyl ether (PBDE), polybrominated biphenyl (PBB), brominated cyclic hydrocarbon, decabromodiphenyl ether (DeBDE), hexabromocyclododecane (HBCDD), tetrabromobisphenol A (TBBP-A), octabromodiphenyl ether (OBDPE), brominated polystyrene, propylene dibromostyrene, brominated epoxy, brominated polycarbonate, chlorinated paraffin, chlorinated polyethylene, alicyclics, or any combinations thereof.

The nitrogen (N)-based flame-retardant material may include melamine polyphosphate (MPP), melamine cyanurate, melamine, melamine isocyanurate, melamine cyanuric acid, a triazine-based compound, or any combinations thereof.

The second conductive material can be applied onto the surface of the core 21 to confer improved electronic conductivity to the flame retardant. The type thereof is not particularly limited and can be a material commonly used in batteries, but may be exemplified by a carbon-based conductive material. For example, the carbon-based conductive material may include carbon black, graphite particles, natural graphite, artificial graphite, acetylene black, Ketjen black, carbon nanofibers, carbon nanotubes, or any combinations thereof. As such, the second conductive material may be the same as or different from the first conductive material.

In an embodiment, the thickness w of the shell 22 may be 2 μm or less. The thickness w of the shell 22 may be 1 μm or less. When the thickness w of the shell 22 is 1 μm or less, flame-retardant performance and electronic conductivity may be improved in a balanced manner without increasing the average particle diameter of the flame retardant. If the thickness w of the shell 22 exceeds 2 μm, the average particle diameter of the flame retardant may excessively increase. Moreover, if the thickness w of the shell 22 exceeds 2 μm and the average particle diameter of the flame retardant can be maintained in an appropriate range, the amount of the flame-retardant material included in the flame retardant may decrease, leading to deteriorated flame-retardant performance. The lower limit of the thickness w of the shell 22 is not particularly limited. For example, the thickness w of the shell 22 may be 10 nm or more, 50 nm or more, or 100 nm or more, for example.

In an embodiment, the average particle diameter d₅₀ of the flame retardant may be 3 μm to 5 μm. The thickness of the flame-retardant layer 20 including the flame retardant may be 10 μm or less. However, if the average particle diameter d₅₀ of the flame retardant exceeds 5 μm, it may be difficult to meet the thickness range of the flame-retardant layer 20. On the other hand, if the average particle diameter of the flame retardant is less than 3 μm, the amount of the flame-retardant material included in the core 21 may be excessively small and flame-retardant performance of the flame-retardant electrode may deteriorate.

In an embodiment, the volume ratio of the core 21 to the sum of the first conductive material and the second conductive material may be 1:1 to 1:100. If the volume of the core is greater than the sum of the volumes of the first and second conductive materials, electronic conductivity of the flame-retardant electrode may decrease, such that the overall electrochemical performance of the battery may deteriorate. If the volume ratio of the core to the sum of the first and second conductive materials exceeds 1:100, energy density of the battery may decrease due to excessively large amounts of the first and second conductive materials.

Because a metal lithium thin film or aluminum thin film that is commonly used as the electrode current collector can be made of a metal material with a smooth surface, adhesion thereof to the electrode active material layer may be low. The flame-retardant layer 20 according to an embodiment of the present disclosure may enhance adhesion to the electrode current collector 10 and the electrode active material layer 30 by conferring a selected, set, or predetermined roughness to the surface of the electrode current collector 10.

In an embodiment, adhesion of the flame-retardant layer 20 to the electrode current collector 10 may be greater than 0.42 gf/mm. In an embodiment, adhesion of the flame-retardant layer 20 to the electrode current collector 10 may be 1.20 gf/mm or more. If the adhesion is less than 0.42 gf/mm, it may be difficult to achieve the purpose of attaining thermal stability and adhesion in a balanced manner. The upper limit of adhesion is not particularly limited. For example, adhesion of the flame-retardant layer 20 to the electrode current collector 10 may be 10 gf/mm or less.

In an embodiment, the flame-retardant layer 20 may include 0.5 wt % to 5 wt % of the binder. If the amount of the binder included in the flame-retardant layer 20 is less than 0.5 wt %, adhesion of the flame-retardant layer 20 to the electrode current collector 10 or the electrode active material layer 30 may decrease. On the other hand, if the amount of the binder exceeds 5 wt %, energy density of the battery including the flame-retardant electrode may decrease.

In addition, an all-solid-state battery including the flame-retardant electrode according to an embodiment of the present disclosure may be provided. FIG. 3 schematically shows an all-solid-state battery in which the electrode according to an embodiment of the present disclosure is applied as a cathode. Referring to FIG. 3, the all-solid-state battery includes a cathode including the flame-retardant electrode, a solid electrolyte layer 40 on the cathode and including a solid electrolyte, an anode active material layer 50 on the solid electrolyte layer 40, and an anode current collector 60 on the anode active material layer 50.

When the flame-retardant electrode is used as a cathode, the electrode current collector 10 may be a cathode current collector 10′, and the electrode active material layer may be a cathode active material layer 30′.

The electrode current collector, which is the cathode current collector 10′, may include a plate-type substrate having electrical conductivity. For example, the cathode current collector 10′ may include an aluminum foil. The thickness of the cathode current collector 10′ is not particularly limited, and may be, for example, 1 μm to 500 μm.

The electrode active material layer, which is the cathode active material layer 30′, may include a cathode active material, a solid electrolyte, a conductive material, a binder, etc. The cathode active material can be capable of intercalating and deintercalating lithium ions, and examples thereof may include a rock-salt-layer-type active material such as LiCoO₂, LiMnO₂, LiNiO₂, LiVO₂, Li₁₊ₓNi_{1/3}Co_{1/3}Mn_{1/3}O₂, etc., a spinel-type active material such as LiMn₂O₄, Li(Ni_{0.5}Mn₁₋₅)O₄, etc., an inverse-spinel-type active material such as LiNiVO₄, LiCoVO₄, etc., an olivine-type active material such as LiFePO₄, LiMnPO₄, LiCoPO₄, LiNiPO₄, etc., a silicon-containing active material such as Li₂FeSiO₄, Li₂MnSiO₄, etc., a rock-salt-layer-type active material in which a portion of a transition metal is substituted with a different metal, such as LiNi_{0.8}Co_{(0.2-x)}AlₓO₂ (0<x<0.2), a spinel-type active material in which a portion of a transition metal is substituted with a different metal, such as Li₁₊ₓMn_{2-x-y}M_{y}O₄ (in which M is at least one selected from among Al, Mg, Co, Fe, Ni, and Zn, 0<x+y<2), lithium titanate such as Li₄Ti₅O₁₂, and the like, for example.

The solid electrolyte may include an oxide-based solid electrolyte or a sulfide-based solid electrolyte. It may be preferable to use a sulfide-based solid electrolyte having high lithium ion conductivity. The sulfide-based solid electrolyte is not particularly limited, but examples thereof may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B2S3-LiI, Li₂S—SiS₂—P₂S₅—LiI, Li₂S—B₂S₃, Li₂S—P₂S₅—ZₘSₙ (in which m and n are positive numbers, and Z is any one selected from among Ge, Zn, and Ga), Li₂S—GeS₂, Li₂S—SiS₂—Li₃PO₄, Li₂S—SiS₂—LiₓMO_{y} (in which x and y are positive numbers, and M is any one selected from among P, Si, Ge, B, Al, Ga, and In), Li₁₀GeP₂S₁₂, and the like, for example. Examples of the oxide-based solid electrolyte may include perovskite-type LLTO (Li₃ₓLa_{2/3-x}TiO₃), phosphate-based NASICON-type LATP (Li₁₊ₓAlₓTi₂₋ₓ(PO₄)₃), and the like, for example.

Examples of the conductive material may include carbon black, conductive graphite, ethylene black, graphene, and the like. The conductive material included in the cathode active material layer 30′ may be a separate component from the first conductive material and the second conductive material included in the flame-retardant layer 20.

Examples of the binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), and the like. The binder included in the cathode active material layer 30′ may be a separate component from the binder included in the flame-retardant layer 20.

The solid electrolyte layer 40 can be between the cathode active material layer 30′ and the anode active material layer 50, and may include a solid electrolyte having lithium ion conductivity.

The solid electrolyte may include an oxide-based solid electrolyte, a sulfide-based solid electrolyte, and the like, for example. It may be preferable to use a sulfide-based solid electrolyte having high lithium ion conductivity.

The sulfide-based solid electrolyte is not particularly limited, and examples thereof may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B2S3-LiI, Li₂S—SiS₂—P₂S₅—LiI, Li₂S—B₂S₃, Li₂S—P₂S₅—ZₘSₙ (in which m and n are positive numbers, and Z is any one selected from among Ge, Zn, and Ga), Li₂S—GeS₂, Li₂S—SiS₂—Li₃PO₄, Li₂S—SiS₂—LiₓMO_{y} (in which x and y are positive numbers, and M is any one selected from among P, Si, Ge, B, Al, Ga, and In), Li₁₀GeP₂S₁₂, and the like. Examples of the oxide-based solid electrolyte may include perovskite-type LLTO (Li₃ₓLa_{2/3-x}TiO₃), phosphate-based NASICON-type LATP (Li₁₊ₓAlₓTi₂—X(PO₄)₃), and the like. The solid electrolyte included in the solid electrolyte layer 40 may be the same as or different from the solid electrolyte included in the cathode active material layer 30′.

The anode active material layer 50 may include an anode active material, a solid electrolyte, a conductive material, a binder, etc.

The anode active material may be a compound capable of reversibly intercalating and deintercalating lithium.

Specific examples of the anode active material may include carbonaceous materials such as artificial graphite, natural graphite, graphitized carbon fiber, and amorphous carbon; metallic compounds capable of alloying with lithium, such as Si, Al, Sn, Pb, Zn, Bi, In, Mg, Ga, Cd, Si alloy, Sn alloy, and Al alloy; metal oxides capable of doping and dedoping lithium, such as SiO_{β}(0<β<2), SnO₂, vanadium oxide, and lithium vanadium oxide; and composites including the above-described metallic compound and carbonaceous material, such as Si—C or Sn—C composites, which may be used alone or in combination of two or more thereof.

Also, a metal lithium thin film may be used as the anode active material.

Because the solid electrolyte, conductive material, and binder included in the anode active material layer 50 can be substantially the same as those included in the cathode active material layer 30′, a redundant description thereof will be omitted.

The anode current collector 60 may include a plate-type substrate having electrical conductivity. For example, the anode current collector 60 may include a material that does not react with lithium. Specifically, the anode current collector 60 may include nickel (Ni), copper (Cu), stainless steel, or any combinations thereof. The thickness of the anode current collector 60 is not particularly limited, and may be, for example, 1 μm to 500 μm.

In addition, an embodiment of the present disclosure pertains to an all-solid-state battery including an anode including the flame-retardant electrode, a solid electrolyte layer on the anode and including a solid electrolyte, a cathode active material layer on the solid electrolyte layer, and a cathode current collector on the cathode active material layer.

When the electrode current collector is used for an anode, the electrode current collector may be an anode current collector and the electrode active material layer may be an anode active material layer. Also, because the solid electrolyte layer, the cathode active material layer, and the cathode current collector can be substantially the same as those described in the all-solid-state battery to which the cathode including the flame-retardant electrode is applied, a detailed description thereof will be omitted.

A better understanding of the present disclosure may be obtained through the following examples and comparative examples. However, these examples are not construed as necessarily limiting the technical spirit of the present disclosure.

### PREPARATION EXAMPLE

(1) Sb₂O₃ as a flame-retardant material and spherical carbon black as a conductive material were prepared in a volume ratio of 1:1. A powder in which a flame-retardant material and a second conductive material were mixed was obtained by mixing Sb₂O₃ and some of spherical carbon black in a weight ratio of 80:20. The powder was placed in a resonant acoustic mixer and mixed for 30 minutes at a gravitational acceleration of 80 G to obtain a flame retardant with a core-shell structure configured such that the surface of a core including the flame-retardant material was coated with a shell including the second conductive material.

(2) A slurry was prepared by adding the flame retardant, butadiene rubber (BR) as a binder, and spherical carbon black remaining after the production of the flame retardant as a first conductive material to butyl butyrate (BB) as an organic solvent, followed by mixing.

(3) A flame-retardant layer 20 was formed on a cathode current collector by applying the slurry onto an aluminum thin film as the cathode current collector, followed by drying.

(4) A cathode active material slurry was prepared by dispersing 80 parts by weight of LiNi_{0.8}Co_{0.1}Mn_{0.1}O₂ as a cathode active material, 20 parts by weight of Li₆PS₅Cl as a solid electrolyte, 2.5 parts by weight of BR as a binder, and 2.5 parts by weight of carbon black as a conductive material in BB as an organic solvent. The cathode active material slurry was applied onto the flame-retardant layer and then rolled with a roll press, thereby manufacturing a flame-retardant cathode.

### Comparative Preparation Example 1

An active material slurry was prepared by dispersing 80 parts by weight of LiNi_{0.8}Co_{0.1}Mn_{0.1}O₂ as a cathode active material, 20 parts by weight of Li₆PS₅Cl as a solid electrolyte, 2.5 parts by weight of BR as a binder, and 2.5 parts by weight of carbon black as a conductive material in BB as an organic solvent. The active material slurry was applied onto an aluminum thin film and then rolled with a roll press, thereby manufacturing a cathode.

### Comparative Preparation Example 2

(1) Sb₂O₃ as a flame-retardant material and spherical carbon black as a conductive material were prepared in a volume ratio of 2:8.

(2) A slurry was prepared by adding Sb₂O₃, butadiene rubber (BR) as a binder, and spherical carbon black as a first conductive material to butyl butyrate (BB) as an organic solvent, followed by mixing.

Thereafter, a cathode was manufactured in the same manner as in Preparation Example.

### Comparative Preparation Example 3

A cathode was manufactured in the same manner as in Comparative Preparation Example 2, with the exception that Sb₂O₃ as a flame-retardant material and spherical carbon black as a conductive material were prepared in a volume ratio of 5:5.

### Comparative Preparation Example 4

A cathode was manufactured in the same manner as in Comparative Preparation Example 2, with the exception that Sb₂O₃ as a flame-retardant material and spherical carbon black as a conductive material were prepared in a volume ratio of 6:4.

### Comparative Preparation Example 5

A cathode was manufactured in the same manner as in Comparative Preparation Example 2, with the exception that Sb₂O₃ as a flame-retardant material and spherical carbon black as a conductive material were prepared in a volume ratio of 7:3.

### Comparative Preparation Example 6

A cathode was manufactured in the same manner as in Comparative Preparation Example 2, with the exception that Sb₂O₃ as a flame-retardant material and spherical carbon black as a conductive material were prepared in a volume ratio of 10:o.

### Test Example 1—Evaluation of Adhesion

The adhesion of the cathode manufactured according to each of Preparation Example and Comparative Preparation Examples was evaluated. The adhesion was measured using a tensile strength tester (Daesung Precision Co., Ltd.) in the following manner.

Each cathode was attached to a slide glass using double-sided adhesive tape. The width of each cathode was cut to match the width of the slide glass, but the length of each cathode was cut sufficiently. A portion thereof attached to the double-sided adhesive tape and a portion thereof not attached thereto were fixed to respective load cells of the tensile strength tester. The load value depending on displacement was measured by applying tensile stress, and a stress value was calculated based thereon. The stress value was named adhesion. The results thereof are shown in Table 1 below, for example.

TABLE 1

| Classification | Adhesion (gf/mm) |
|---|---|
| Preparation Example | 1.23 |
| Comparative Preparation Example 1 | 1.347 |
| Comparative Preparation Example 2 | 0.935 |
| Comparative Preparation Example 3 | 1.24 |
| Comparative Preparation Example 4 | 1.56 |
| Comparative Preparation Example 5 | 1.235 |
| Comparative Preparation Example 6 | 0.42 |

As shown in Table 1, the adhesion of Comparative Preparation Example 6, in which the flame-retardant layer 20 was not formed between the cathode current collector 10′ and the cathode active material layer 30′, was measured to be the lowest. Accordingly, the flame-retardant layer 20 including a flame retardant, a binder, and a first conductive material was confirmed to enhance adhesion to the cathode current collector 10′ and the cathode active material layer 30′. This is deemed to be because surface roughness of the cathode current collector 10′ is improved due to insertion of the flame-retardant layer 20.

### Test Example 2—Evaluation of Electronic Conductivity

To determine the effect of the flame-retardant layer 20 on electronic conductivity of the cathode, electronic conductivity of the cathode according to each of Preparation Example and Comparative Preparation Examples was measured, and the results thereof are shown in Table 2 below. As such, electronic conductivity of the cathode was measured using an electrode electronic conductivity meter (e.g., Biologic, VMP-300).

TABLE 2

| | Electronic conductivity of cathode |
|---|---|
| Classification | (mS/cm) |
| Preparation Example | 1.865 |
| Comparative Preparation Example 1 | 2.814 |
| Comparative Preparation Example 2 | 1.784 |
| Comparative Preparation Example 3 | 0.728 |
| Comparative Preparation Example 4 | 0.422 |
| Comparative Preparation Example 5 | 0.055 |
| Comparative Preparation Example 6 | 0.015 |

As shown in Table 2, the electronic conductivity of Comparative Preparation Example 1, which did not include the flame-retardant layer 20, was measured to be the highest. Referring to the results of Comparative Preparation Example 2 to Comparative Preparation Example 6, electronic conductivity decreased with a decrease in the amount of the conductive material included in the flame-retardant layer 20.

When comparing Preparation Example with Comparative Preparation Example 3, the total volume ratio of the flame retardant to the conductive material included in the flame-retardant layer 20 was the same, but the electronic conductivity of Preparation Example including the flame retardant with a core-shell structure was measured to be higher than that of Comparative Preparation Example 3.

### EXAMPLE

An electrode assembly was manufactured by stacking an anode current collector 6o, an anode active material layer 5o, a solid electrolyte layer 40, and the flame-retardant cathode according to Preparation Example. A pouch-type all-solid-state battery was obtained by placing the electrode assembly in a case.

A nickel (Ni) thin film was used as the anode current collector. The anode was composed of 60 parts by weight of silicon (Si) and natural graphite as anode active materials, 40 parts by weight of Li₆PS₅Cl as a solid electrolyte, and 2 parts by weight of BR as a binder. The solid electrolyte layer was composed of 97 parts by weight of Li₆PS₅Cl as a sulfide-based solid electrolyte and 3 parts by weight of BR as a binder.

### Comparative Example 1

An all-solid-state battery was obtained in the same manner as in Example, with the exception that the cathode according to Comparative Preparation Example 1 was used.

### Comparative Example 2

An all-solid-state battery was obtained in the same manner as in Example, with the exception that the cathode according to Comparative Preparation Example 2 was used.

### Comparative Example 3

An all-solid-state battery was obtained in the same manner as in Example, with the exception that the cathode according to Comparative Preparation Example 3 was used.

### Comparative Example 4

An all-solid-state battery was obtained in the same manner as in Example, with the exception that the cathode according to Comparative Preparation Example 4 was used.

### Comparative Example 5

An all-solid-state battery was obtained in the same manner as in Example, with the exception that the cathode according to Comparative Preparation Example 5 was used.

### Comparative Example 6

An all-solid-state battery was obtained in the same manner as in Example, with the exception that the cathode according to Comparative Preparation Example 6 was used.

### Test Example 3—Evaluation of Thermal Stability Using ARC

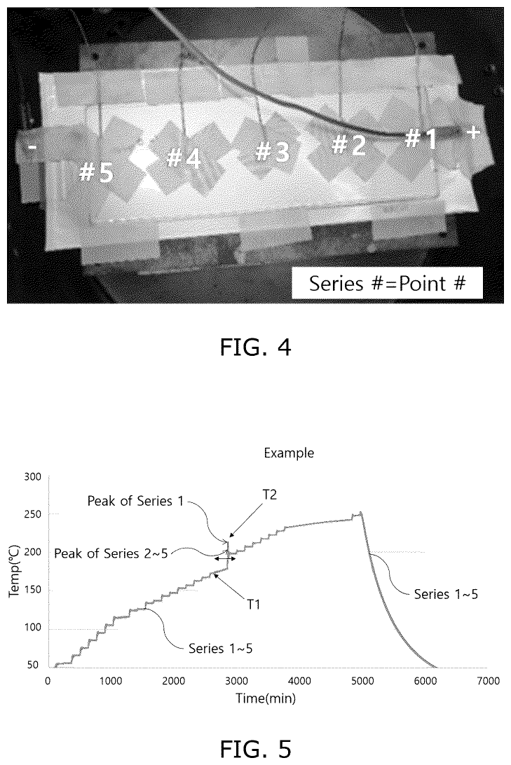

FIG. 4 shows a photograph of an accelerating rate calorimeter (ARC) for measuring the thermal stability of the all-solid-state batteries according to Example and Comparative Example 1. The all-solid-state battery according to each of Example and Comparative Examples was charged at 4.25 V SOC 100% and then heated in an insulated state to measure temperature change of the cell. Here, measurement was performed on series 1 to 5 to confirm the area of occurrence of thermal runaway in the all-solid-state battery. When the battery self-heating reaction was measured, the temperature increase was stopped and the heating temperature of the battery was measured. Specific ARC evaluation conditions are shown in Table 3 below.

TABLE 3

| Start | End | | Increase | Stabilization time |
|---|---|---|---|---|
| temperature | temperature | Sensitivity | step | after increase |
| 50° C. | 250° C. | 0.02° C./ | 5° C. | 50 min |
| | | min | | |

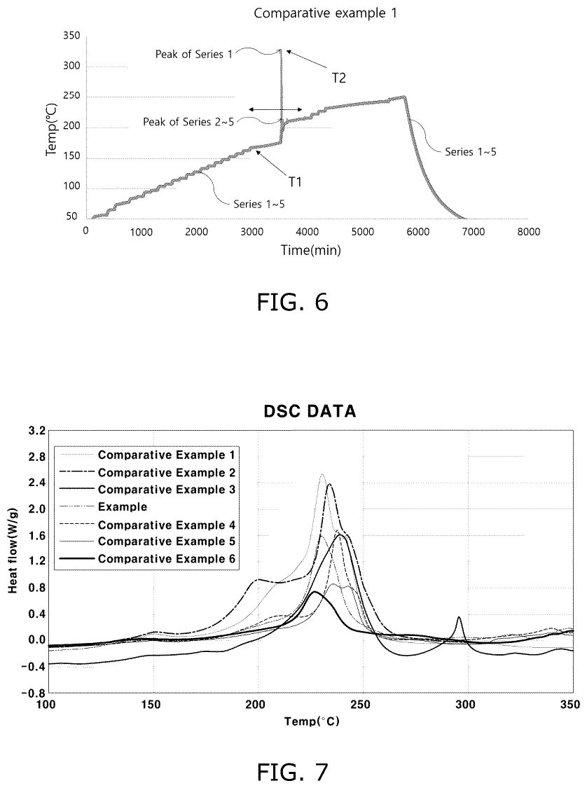

FIG. 5 shows results of analysis of the all-solid-state battery according to Example using an accelerating rate calorimeter. FIG. 6 shows results of analysis of the all-solid-state battery according to Comparative Example 1 using an accelerating rate calorimeter. Here, T₁ is the self-heating start temperature of the all-solid-state battery, and T₂ is the thermal runaway temperature. Also, the flat section before and after T₂ was set as the heating section. The results thereof are shown in Table 4 below.

TABLE 4

| | T₁ | T₂ | Heating Section |
|---|---|---|---|
| Example | 174.87° C. | 213.46° C. | Short |
| Comparative Example 1 | 166.78° C. | 328.7° C. | Long |

Referring to FIG. 5, the accelerating rate calorimeter analysis results of Series 1 to Series 5 for Example 1 were observed to be very similar and difficult to distinguish from each other. In this case, a peak was observed at about 2900 min. The peak temperatures of Series 2 to 5 were similar to each other, and a thermal runaway temperature (T₂) was observed in Series 1.

According to FIG. 6, the accelerating rate calorimeter analysis results of Series 1 to Series 5 for Comparative Example 1 were observed to be very similar and difficult to distinguish from each other. In this case, a peak was observed around 3500 min, and the peak temperatures of Series 1 to 4 were similar to each other, and a noticeable thermal runaway temperature (T₂) was observed in Series 5.

As shown in FIGS. 5 and 6 and Table 4, when the flame-retardant layer 20 including the flame retardant with a core-shell structure was applied to the cathode, the self-heating start temperature of the all-solid-state battery including the same increased and the maximum temperature during thermal runaway decreased. Moreover, the heating section before and after the time point of thermal runaway was shortened. Therefore, thermal stability of the all-solid-state battery according to Example was confirmed to be improved compared to Comparative Example 1.

### Test Example 4—Evaluation of Thermal Stability Using DSC

To determine the amount of heat generated in the all-solid-state batteries according to Example and Comparative Examples, the all-solid-state batteries were analyzed using differential scanning calorimetry (DSC), and the results thereof are shown in FIG. 7 and Table 5 below.

TABLE 5

| | Onset temperature | Amount of heat |
|---|---|---|
| Classification | (° C.) | generated (J/g) |
| Example | 205.75 | 438.0 |
| Comparative Example 1 | 176 | 930.5 |
| Comparative Example 2 | 172 | 861.49 |
| Comparative Example 3 | 202 | 453.4 |
| Comparative Example 4 | 203 | 428.52 |
| Comparative Example 5 | 219 | 246.11 |
| Comparative Example 6 | 212 | 219.56 |

As shown in Table 5, the amount of heat generated decreased with an increase in the amount of the flame retardant included in the flame-retardant layer 20. Moreover, the onset temperature generally increased with an increase in the amount of the flame retardant.

### Test Example 5—Evaluation of Electrochemical Properties of all-Solid-State Battery

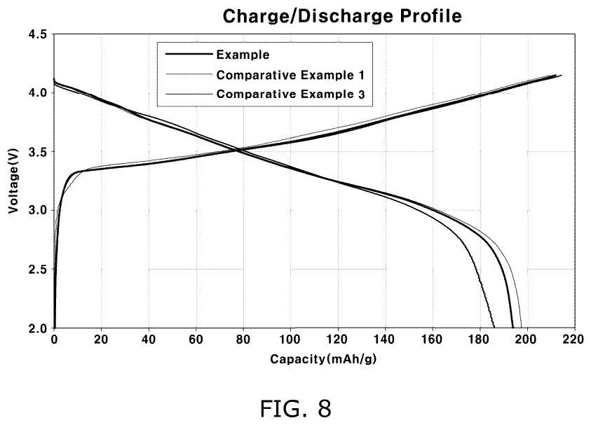

Charge/discharge tests were performed on Example, Comparative Example 1, and Comparative Example 3. The discharge end voltage and the charge end voltage were set to 2.0 V and 4.25 V, respectively, and the rate was set to 0.2 C. The results thereof are shown in FIG. 8.

Referring to FIG. 8, discharge capacity of the all-solid-state battery according to Example was measured to be about 193 mAh/g, discharge capacity of the all-solid-state battery according to Comparative Example 1 was measured to be about 197 mAh/g, and discharge capacity of the all-solid-state battery according to Comparative Example 3 was measured to be about 185 mAh/g.

Thereby, Example using the flame retardant with a core-shell structure was confirmed to exhibit superior discharge capacity compared to Comparative Example 3 using the flame retardant without the second conductive material. Also, discharge capacity of Example was found to be similar to that of Comparative Example 1 not including the flame-retardant layer 20.

As is apparent from the above description, an electrode according to an embodiment of the present disclosure includes a flame-retardant layer disposed between an electrode current collector and an electrode active material layer, and the flame-retardant layer includes all of a flame retardant, a binder, and a conductive material, so that thermal stability and adhesion can be increased.

In particular, the flame retardant can have a core-shell structure with a flame-retardant material as a core and a conductive material as a shell, thereby increasing thermal stability and adhesion, and also ensuring electrochemical performance that is similar to an all-solid-state battery that does not include the flame-retardant layer.

Embodiments and advantages of the present disclosure are not necessarily limited to the above-mentioned embodiments and advantages. It can be understood that an embodiment of the present disclosure can include all effects and advantages that can be inferred from the description of the present disclosure.

What is claimed is:

1. A flame-retardant electrode, comprising:
an electrode current collector;
an electrode active material layer; and
a flame-retardant layer between the electrode current collector and the electrode active material layer,
wherein the flame-retardant layer comprises a flame retardant with a core-shell structure, a binder, and a first conductive material, and
wherein the flame retardant comprises a core comprising a flame-retardant material and a shell comprising a second conductive material applied onto at least a portion of a surface of the core.

2. The flame-retardant electrode of claim 1, wherein a thickness of the flame-retardant layer is 10 μm or less.

3. The flame-retardant electrode of claim 1, wherein a thickness of the shell is 2 μm or less.

4. The flame-retardant electrode of claim 1, wherein an average particle diameter of the flame retardant is 3 μm to 5 μm.

5. The flame-retardant electrode of claim 1, wherein a volume ratio of the core to a sum of the first conductive material and the second conductive material is 1:1 to 1:100.

6. The flame-retardant electrode of claim 1, wherein the flame-retardant material comprises at least one material selected from the group consisting of an inorganic flame-retardant material, a phosphorus(P)-based flame-retardant material, a halogen-based flame-retardant material, and a nitrogen (N)-based flame-retardant material, and combinations thereof.

7. The flame-retardant electrode of claim 1, wherein the flame-retardant material comprises at least one inorganic flame-retardant selected from the group consisting of aluminum hydroxide (Al(OH)3), magnesium hydroxide (Mg(OH)2), antimony oxide (Sb2O3), tin hydroxide (Sn(OH)2), tin oxide (SnO), molybdenum oxide (MoO3), a zirconium compound, a calcium salt, and a boron compound, and combinations thereof.

8. The flame-retardant electrode of claim 1, wherein the flame-retardant material comprises at least one phosphorus (P)-based flame-retardant material selected from the group consisting of a red-phosphorus (RP)-based flame-retardant material, a phosphate-based flame-retardant material, a phosphine-based flame-retardant material, a phosphite-based flame-retardant material, a phosphonate-based flame-retardant material, a phosphinate-based flame-retardant material, a phosphoric acid ester flame-retardant material, a phosphoric acid ester and salt flame-retardant material, and combinations thereof.

9. The flame-retardant electrode of claim 1, wherein the flame-retardant material comprises at least one halogen-based flame-retardant material selected from the group consisting of polybrominated diphenyl ether (PBDE), polybrominated biphenyl (PBB), brominated cyclic hydrocarbon, decabromodiphenyl ether (DeBDE), hexabromocyclododecane (HBCDD), tetrabromobisphenol A (TBBP-A), octabromodiphenyl ether (OBDPE), brominated polystyrene, propylene dibromostyrene, brominated epoxy, brominated polycarbonate, chlorinated paraffin, chlorinated polyethylene, and alicyclics, and combinations thereof.

10. The flame-retardant electrode of claim 1, wherein the flame-retardant material comprises at least one nitrogen (N)-based flame-retardant material selected from the group consisting of melamine polyphosphate (MPP), melamine cyanurate, melamine, melamine isocyanurate, melamine cyanuric acid, and a triazine-based compound, and combinations thereof.

11. The flame-retardant electrode of claim 1, wherein adhesion of the flame-retardant layer to the electrode current collector is 1.20 gf/mm or more.

12. The flame-retardant electrode of claim 1, wherein the flame-retardant layer comprises 0.5 wt % to 5 wt % of the binder.

13. The flame-retardant electrode of claim 1, wherein the first conductive material and the second conductive material comprise a carbon-based conductive material.

14. An all-solid-state battery, comprising:
an cathode current collector;
an cathode active material layer; and
a flame-retardant layer between the cathode current collector and the cathode active material layer, wherein the flame-retardant layer comprises a flame retardant with a core-shell structure, a binder, and a first conductive material, and wherein the flame retardant comprises a core comprising a flame-retardant material and a shell comprising a second conductive material applied onto at least a portion of a surface of the core, wherein the cathode current collector, the cathode active material layer, and the flame-retardant layer form a cathode;
a solid electrolyte layer on the cathode and comprising a solid electrolyte;
an anode active material layer on the solid electrolyte layer; and
an anode current collector on the anode active material layer.

15. The all-solid-state battery of claim 14, wherein a thickness of the flame-retardant layer is 10 μm or less, a thickness of the shell is 2 μm or less, and an average particle diameter of the flame retardant is 3 μm to 5 μm.

16. The all-solid-state battery of claim 14, wherein the flame-retardant material comprises at least one material selected from the group consisting of an inorganic flame-retardant material, a phosphorus(P)-based flame-retardant material, a halogen-based flame-retardant material, and a nitrogen (N)-based flame-retardant material, and combinations thereof.

17. An all-solid-state battery, comprising:
an anode current collector;
an anode active material layer; and
a flame-retardant layer between the anode current collector and the anode active material layer, wherein the flame-retardant layer comprises a flame retardant with a core-shell structure, a binder, and a first conductive material, and wherein the flame retardant comprises a core comprising a flame-retardant material and a shell comprising a second conductive material applied onto at least a portion of a surface of the core, wherein the anode current collector, the anode active material layer, and the flame-retardant layer form an anode;
a solid electrolyte layer on the anode and comprising a solid electrolyte;
a cathode active material layer on the solid electrolyte layer; and
a cathode current collector on the cathode active material layer.

18. The all-solid-state battery of claim 17, wherein a thickness of the flame-retardant layer is 10 μm or less, a thickness of the shell is 2 μm or less, and an average particle diameter of the flame retardant is 3 μm to 5 μm.

19. The all-solid-state battery of claim 17, wherein the flame-retardant material comprises at least one material selected from the group consisting of an inorganic flame-retardant material, a phosphorus(P)-based flame-retardant material, a halogen-based flame-retardant material, and a nitrogen (N)-based flame-retardant material, and combinations thereof.
